(19) United States
(12) Patent Application Publication
(10) Pub. No.: US 2016/0239890 A1
(43) Pub. Date: Aug. 18, 2016

(54) System for referring a product to a professional

(71) Applicant: Ramesh Sesha, Conroe, TX (US)

(72) Inventor: Ramesh Sesha, Conroe, TX (US)

(21) Appl. No.: 14/998,712

(22) Filed: Feb. 4, 2016

Related U.S. Application Data
(63) Continuation of application No. 62/111,495, filed on Feb. 3, 2015.

(51) Int. Cl. G06Q 30/06; G06F 17/30; G06Q 50/12

(52) U.S. Cl. CPC G06Q 30/0613; G06Q 30/0625; G06Q 50/12; G06F 17/30867; G06F 17/3053; G06F 17/30554

(57) ABSTRACT

The invention relates to methods and systems for referring products to a professional for advice.

### FIELD OF THE INVENTION

The invention involves a computer implemented system for referring products to a professional, wherein the referred product includes at least one characteristic that enables the professional to determine the utility of the product.

### BACKGROUND OF THE INVENTION

The Internet retail platform provides a global access to vast array of goods and services that are accessed by users to download and review informational pages to assess a product or a service that is of interest to him/her.

In some cases, retailers attempt to appeal to an individual customer by highlighting consumer rating of products and based on what other customers may have purchased who bought products feel about it. However, the retailer often does not know why the other customers selected the product and so such rating may accurately reflect the actual impact of product when used by a user depending on his or her personal situation.

It is very useful if such assessment is made by a professional and advice users. This is particularly important in the case of product and services that require technical or professional competence such as a medical devices, nutritional products and food, device and engineering products. The user may not have the knowledge to determine how product attributes may affect its utility. One approach is to use a professional to review the product attribute and then make recommendation based on the user's profile. Thus there is a need for computer implemented systems to refer a product to a professional wherein the referred product includes at least one characteristic that enable the professional to determine its utility. The present invention provides systems and methods for referring products that provides such solutions.

### SUMMARY OF THE INVENTION

The invention provides a computer implemented method for referring an item to a Professional wherein the method comprises receiving a request to refer an item from a client; and transmitting the request comprising item information to a Professional.

The invention provides a computer implemented method for referring an item to a Professional wherein the method comprises receiving a request to refer an item from a client; and transmitting the request comprising item information to a Professional and the referred product includes at least one characteristic that enables the Professional to determine its utility.

The invention provides a computer implemented method for referring an item to a Professional wherein the method comprises receiving a request to refer an item from a client; and transmitting the request comprising item information to a Professional and the referred product includes at least one characteristic that enables the Professional to determine its utility. The Professional is a nutritionist.

The invention provides a computer implemented method for referring an item to a Professional wherein the method comprises receiving a request to refer an item from a client and transmitting the request comprising item information to a Professional. The process is a single step.

The invention provides a computer implemented method for referring an item to a Professional wherein the method comprises receiving a request to refer an item from a client; and transmitting the request comprising item information to a Professional. The number of steps to reter a product is a maximum of two steps.

The invention provides a computer implemented method for referring an item to a Professional wherein the method comprises receiving a request to refer an item from a client; and transmitting the request comprising item information to a Professional. The number of steps to refer a product is a maximum of three steps.

The invention provides a computer implemented method for referring an item to a Professional wherein the method comprises receiving a request to refer an item from a client; and transmitting the request comprising item information to a Professional wherein at least one characteristic of the product is initially identified and a pre-generated item-characteristic table is created.

The present invention provides a system, comprising: at least one computing device, configured to at least: to receive a request to refer an item from a client; select an item from an electronic catalog; and transmit the item information to a Professional;

The present invention provides a system, comprising: at least one computing device, configured to at least: to receive a request to refer an item from a client; select an item from an electronic catalog; and transmit the item information to a Professional; The process is a single step.

The present invention provides a system, comprising: at least one computing device, configured to at least: to receive a request to refer an item from a client; select an item from an electronic catalog; and transmit the item information to a Professional; The number of steps to refer a product is a maximum of two steps.

The present invention provides a system, comprising: at least one computing device, configured to at least: to receive a request to refer an item from a client; select an item from an electronic catalog; and transmit the item information to a Professional; The number of steps to refer a product is a maximum of three steps

The present invention provides a system, comprising: at least one computing device, configured to at least: to receive a request to refer an item from a client; select an item from an electronic catalog; and transmit the item information to a Professional. The Professional is a nutritionist.

The invention provides a computer implemented system for referring products, wherein the system comprises at least database server, at least one referral engine and the referred product includes at least one characteristic that enables the Professional to determine its utility.

The invention provides a computer implemented system for referring products, wherein the system comprises at least database server, at least one referral engine and the referred product includes at least one characteristic that enables the Professional to determine its utility. The number of steps to refer a product is a maximum of two steps.

The invention provides a computer implemented system for referring products, wherein the system comprises at least database server, at least one referral engine and the referred product includes at least one characteristic that enables the Professional to determine its utility. The number of steps to refer a product is a maximum of three steps.

The invention provides a computer implemented system for referring products, wherein the system comprises at least one database server, at least one referral engine and the referred product includes at least one characteristic that enables the Professional to determine the product's composition. The professional is a nutritionist.

In one embodiment, the computer implemented system for referring products, wherein the system comprising; at least database server, at least one referral engine and creating a table of plurality of products so each product is associated with a plurality of characteristics, with at least one of the plurality of characteristics is included in the referred product.

The present invention provides a computer implemented system for referring a product to professional, wherein the system including; one or more processors; and memory storing instructions that when executed by the processors cause the processors to perform operations including: identifying the product and identifying or inferring at least one characteristic of the identified product and transmitting product information to a professional.

The present invention provides a computer implemented system for referring a product to professional, wherein the system including; one or more processors; and memory storing instructions that when executed by the processors cause the processors to perform operations including; identifying the product and identifying or inferring at least one characteristic of the identified product and transmitting product information to a professional. The number of steps to refer a product is a maximum of three steps.

The present invention provides a computer implemented system for referring a product to professional, wherein the system including; one or more processors; and memory storing instructions that when executed by the processors cause the processors to perform operations including; identifying the product and identifying or inferring at least one characteristic of the identified product and referring product information to a professional. The process is a single step.

The present invention provides a computer implemented system for referring a product to professional, wherein the system including; one or more processors; and memory storing instructions that when executed by the processors cause the processors to perform operations including; identifying the product and identifying or inferring at least one characteristic of the identified product and referring product information to a professional. The referred items are from a shopping cart.

The present invention provides a computer implemented system for referring a product to professional, wherein the system including; one or more processors; and memory storing instructions that when executed by the processors cause the processors to perform operations including; identifying the product and identifying or inferring at least one characteristic of the identified product, identifying a list of products ranked according to the said characteristic and referring product information to a professional along with a list of alternative products based on the ranking.

The present invention provides a non-transitory computer-readable medium embodying a program executable in a computing device, the program, when executed, causing the computing device to at least: receive request to refer an item from a client; select an item from an electronic catalog; and transmit the item information to a Professional.

### BRIEF DESCRIPTION OF THE DRAWINGS

FIG. 1 illustrates the architecture of the system of referring products according to this invention.

FIG. 2 illustrates an implementation of processes that are performed to refer products.

FIG. 3 illustrates a sequence of steps that are performed to gather items from a data source and create a table of item-product codes.

FIG. 4 illustrates a sequence of steps that are performed for creating a table of items-product characteristics.

FIG. 5 illustrates a sequence of steps for creating item-normalized characteristic using an algorithm.

FIG. 6 illustrates a sequence of steps for referring products in the database by comparing the user determined specific characteristic and providing the results.

FIG. 7 illustrates one specific implementation of FIG. 1, which embodies various inventive features and how different components interact with another, to recommend food products using sugar content % in products.

FIG. 8 illustrates a computer display of Client referring his/her shopping cart product with a message to a Registered Dietitian.

FIG. 9 illustrates a message alert received by a Registered Dietitian upon referral of shopping cart products

FIG. 10 illustrates the display of referred product to a Registered Dietitian

FIG. 11 illustrates one method of enabling rapid referral of single product with an Icon on display

FIG. 12 illustrates the message of rapid referral of single product to a Registered Dietitian.

### DETAILED DESCRIPTION OF THE INVENTION

### Cross-Reference to Related Applications

This application is a continuation of and claims the benefit of U.S. patent application Ser. No. 62/111,695, entitled “SYSTEM FOR REFERRING A PRODUCT TO A PROFESSIONAL” and filed Feb. 4, 2015, which is hereby incorporated by reference in its entirety.

Detailed description set forth below are only for illustrative purposes. It will be apparent, however, that the present invention may be practiced without these specific details. In other instances, well-known structures and devices are shown in block diagram form in order to avoid unnecessarily obscuring the present invention. Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

The term “one embodiment” or “an embodiment” as used herein means that a particular feature, structure, or characteristic described in conjunction with the embodiment can be included in at least one embodiment of the invention. The appearances of the phrase “in one embodiment” in various places in the specification do not necessarily all refer to the same embodiment.

The term “Attributes” or “Attribute” or “Characteristic” or “Characteristics” as used herein means a property of a product or an item or a service. Its meaning encompasses the inherent properties like ingredient or a group of ingredients, measurement numbers/figures, density, solubility, boiling point, effective properties such as relief, toxicity, weight loss or adhesiveness, shining, reflective characteristic, specific contents like nutrition facts, proteins, fats, sugar content, etc.

The term “computer or computer device or device” as used herein means any device having appropriate processor, memory, and communications capabilities for interacting with the user and communicating with network including but not limited to desktop computers, laptop computers, mobile devices including a smart phone, tablet computer, personal digital assistant, set top boxes (e.g., for a television), televisions, video game consoles, home appliances (e.g. a refrigerator, microwave oven, washer, or dryer), mobile vehicles and automobile-based computer (e.g., an in-dash navigation system).

The term “product” or “item” or “service” as used herein means any product or service are used interchangeably.

The term “Referral” or “referring” as used herein means a electronically forwarding or sending a product or an item or service identified using the system according to this invention to a professional.

The term “Recommendation” as used herein means a product or an item or service identified using the recommendation method according to this invention.

The term “Professional” as used herein means a person who engages in a job that requires special education, training, or skill including but not limited to a medical professional, engineering professional, culinary professional, etc. They specifically include but not limited to a Registered Dietitian, a Nutritionist, a Registered Nurse, Diabetes Educator, a Chef and a Physician.

The term “Profile” or “User's profile” as used herein means a profile created about a user either by the user or on behalf of him by someone else including the computer implemented system. It includes biographical information, preferences/likes and dislikes entered into the user's account in the system.

The term “User” as used herein means the actual user of the system or his designated person including user's counselor, family member or friend who enter data and seek service on behalf of the user.

The term “user interface” as used herein means desktop computers, laptop computers, mobile devices including a smart phone, tablet computer, personal digital assistant, set top boxes (e.g., for a television), televisions, video game consoles, home appliances (e.g. a refrigerator, microwave oven, washer, or dryer) or any other devices having appropriate processor, memory, and communications capabilities for interacting with the user and communicating with a web server.

The terms “derived characteristic or normalized characteristic or standardized score” as used herein means a characteristic that is standardized using mathematical formula and used for referring products or services.

### Overview

Although various embodiments described herein generally describe referring a product or a shopping cart, the present disclosure is not limited as such. Various embodiments of the present disclosure may be used to refer products from any number of situations to help a professional determine its utility based attributes or product features.

The invention discloses a computer implemented method for referring an item with at least one characteristic in items to a professional, wherein the characteristic enables the professional the utility of product such as product's quality or performance. The invention discloses a system for referring products to professional wherein the referred product includes at least one characteristic that enables professional to determine product's quality or performance.

The invention has been described in terms of certain preferred embodiments like referring a food item to a professional, other embodiments that are apparent to those of ordinary skill in the art, including embodiments that do not provide all of the features and benefits set forth herein, are also within the scope of this invention. The invention can be implemented for referring paints, cosmetics by cosmetic scientist, etc. Accordingly, the scope of the present invention is intended to be defined only by reference to the appended claims.

Any reference characters used to denote process steps are provided for convenience of description only, and not to imply a particular order for performing the steps. It will be evident, however, to one skilled in the art that the present invention may be practiced without these specific steps and processes outlined in examples and figures.

The invention is exemplified by referring food products to a professional from an online store selling grocery items or restaurant menu items. Any network that enables client-server interaction can be used to implement the example. For example, it can be implemented in different settings like local area network (LAN) or a wide area network (WAN) or over internet.

A user seeking recommendation or advice about a food product from a professional in an online store or in physical store refers the product by transmitting product and other product information that includes at least one product characteristic or attribute. The characteristic could be the nutrition facts such as calories, sugars, total carbohydrates, proteins and fats. This is important because the user may not have the required professional knowledge to determine the utility of the product thus requiring the help of a professional.

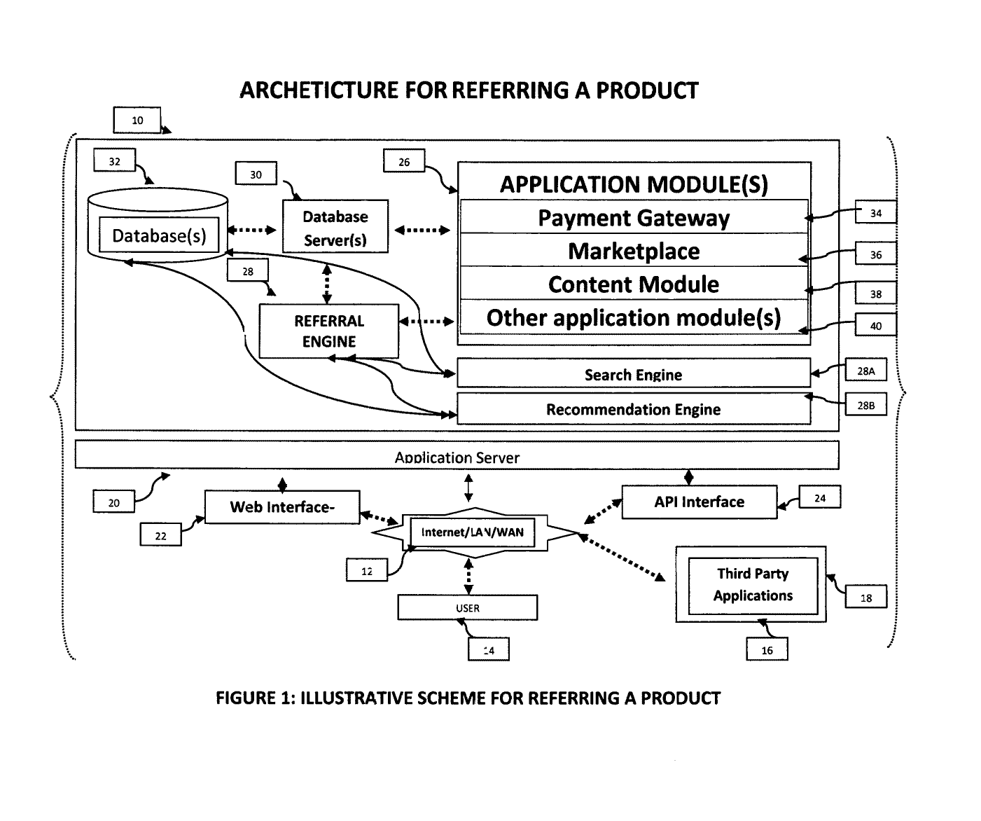

FIG. 1 illustrates exemplary architecture, according to an embodiment of the invention as one implementation of referring a product to a professional for advice and to determine the utility of the referred product. As described herein FIG. 1, one or more embodiments of the invention comprise application server that include several application modules such as referral, marketplace, payment, content, recommendation and search engines, at least one web interface, a database server and optionally an API interlace in a network. The figure shows the exemplary architecture for referring at least one product to a professional. The referring methods and systems can optionally capture geo-location information of the users.

The scheme in FIG. 1 illustrates, in one embodiment, a client-server network 10 with server and client side functionalities are provided via a network such as LAN, WAN or internet 12. The clients 14 and 16 represent the client sides like user(s) and third party application provider(s) respectively. The server side comprises application server 20, database server 30, etc are connected to network 12. The application server(s) 20 may optionally connected to a web interface 22, an API interface 24 and may include a referral module 28 to interact with database server 30. The application server(s) 20 host may host at least one application module 26 and often several applications such as marketplace application, payment processing module, content management module, admin module etc. The referral module 28 in the application server(s) 20 is interacts with database(s) via database server(s) 30. The entire server side 10 connected to network 12 may also an optional firewall. The web interface 22 provides the user (also designed as referral requestor) 14 the access to the server side 10 via network 12. Similarly the API interface 24 is connected to the network to provide external API support for applications running on application server(s)

The client machine 14 can be any communication interface including but not limited to desktop computers, laptop computers, mobile devices including a smart phone, tablet computer, personal digital assistant, set top boxes (e.g., for a television), televisions, video game consoles, home appliances (e.g. a refrigerator, microwave oven, washer, or dryer) or any other devices having appropriate processor, memory, and communications capabilities for interacting with the user and communicating with network as disclosed in this invention. It can be other forms of mobile devices including any of a variety of different types of computing devices having an energy storage device (e.g., a battery) and being capable of communicating via a network, for example via a wireless area network or a cellular network. In some cases, the client/mobile devices 14 are handheld mobile computing devices, such as smart phones, tablets, or the like, or the mobile devices or other special-purpose computing devices, such as an automobile-based computer (e.g., an in-dash navigation system). The client/mobile devices 14 may have a processor and a tangible, non-transitory machine-readable memory storing instructions that provide the functionality described herein when executed by the processor. The memory may store instructions for an operating system, special-purpose applications (apps), and a web browser, depending upon the use case. It should be noted, however, that the present techniques are not limited to mobile devices, and other computing devices subject to geolocation may also generate data useful for identifying user location relevant to store carrying an item. For instance, set-top boxes, gaming consoles, or Internet-capable televisions may be geolocated based on IP address, and data from user interactions with these devices may be used to update user profiles, e.g., with user interaction indicating a time at which a user was at the geolocation corresponding to the device.

The client 14 can consent to capture information in numerous ways. For example, a consumer using client device may enter information via web server 22 or a user in a retail store may use a mobile device equipped with barcode scanning software to capture product related information that is processed for referring at least one product to a professional. It may be a an image captured by the camera which is matched with the product images stored in a data server to retrieve the product information needed to perform a task needed to complete the referral.

The third party application(s) 16 can be any application provided by other service providers. It can be any third party service or functionality interface such as login, payment, market place, a third party database (s) like product codes, product characteristics, content, publications or API provider (s). For illustration, a typical third party application may be a software application associated with a computing device including a mobile device. In order for the application server 16 to respond to a user 14 query, the software application associated with the a third party device may need to perform certain functions such as authentication or payment authorization. Third party applications may run on third party server(s) 18 or may share the same network as the application server 20. The third-party applications may be cloud-based applications that may be used to perform certain tasks such as recipe generation, application to verify UPC codes with an external database, preview, or edit a file. A third party application could reside in a device used by a user. For example—Linkedin or Facebook log in page used by user to log in as a client 14. It could be a Google map that helps the application server 20 to identify the geolocation of the user. The third party applications 16 include a data source or product uploads done in batch processes or one off product or content listing from third party vendors. It can be collection of market places providing a number of products, content API sources from several third party market places like Wal-Mart, Shop & Stop, Peapod, Amazon, Google Express. Shoprite, GNC, etc.

Application server (s) 20 is the key component of the network and it can comprise at least one or more likely a number of specific modules. A server is an entity that receives requests from clients, and responds to those requests by providing some type of service. An application server is capable of simultaneously receiving requests, processing requested work, and returning results using multiple, conceptual thread pools. For example: an application server can be used to authenticate users, view server files, provide access to data within one or more databases, manage e-mail, and provide access to web sites, among other things. The application module 26 includes a referral module 28 and may optionally include other applications such as recommendation 28A, search 28B, payment 34, marketplace 36, content 38 and other modules 40. It may involve product image analysis application that can perform various image analysis techniques on the various images to extract product attributes, characteristics, ingredients, dimensions, and other data that is printed on the product's packaging. These applications are shown schematically for illustrative purposes and are not according to any specific order. In alternative embodiments the application modules may be configured individually or in different orders within or outside the network and within and outside the server side. However, it is possible, depending on the network design, to use a series of special purpose servers, each responsible for specific application, also can be used to provide each of these types of services, rather than employing a generic application server.

Payment module 34 is an internal application for processing with external payment/card service providers like Paypal, Amazon payment, Stripe, Apple pay, Google payments, credit card gateways—Master Card, Visa, American Express Discovery, etc. The module(s) provides number of functional capabilities to clients and server side(s) such as order processing, client analytics, currency exchange, coordination with market place application, shipping module(s) for orderly tracking of shipment and banking via external payment application service provider(s) 16 via secure network 12 and optionally a firewall.

Marketplace application 36 provides the products and services to the client via network 12 on his/her web interface 20. An online marketplace enables the exchange of products and services for payments between sellers and buyers. There are a number of online marketplaces that are customized to products and services. They include Megento, Prestashop, Xcart, Shopify, Opencart, etc. Marketplaces interactively works with other applications like payment gateway 36, content module 38, API interface 24, referral module 28 and third party application(s) to smoothly enable transactions.

Referral engine 28 is the most critical application of the invention to refer at least one product to a professional. The referral engine collects information from a variety of sources, processes to generate additional information about a product or service that includes product content, characteristics, use or any other product matter. Referral engines may be dynamic and real time or back office referring at least one product in the backend to a professional depending prior history. For instance—a user may have added products to the shopping cart in a previous browsing session and referral engine infers, based on certain criteria, that user wanted the product sent to a Professional and accordingly may execute the referral as though requested in the current browsing session. The present invention includes at least one referral engine to complete the referral process. Alternatively, it may involve a series of referral engines acting synergistically to complete the referral of an item. It is also possible to have a plurality of referral engines compiling user information, in real time, into a plurality of referrals. For example it is possible to have one engine referring at least one aspect of at least one product while the second engine may transmit another aspect of the product or one referral engine may refer one product while the second referral engine may refer a second product. Referral engine may include one or more algorithms that process information according pre-defined instructions. Irrespective of how each aspect of referral is generated, a data repository stores the plurality of referral characteristics generated by one or more referral engines. Regardless of the particular type of information collected, referral engine collects the information, processes and transmits product information for a professional such a Registered Dietitian. The plurality of referred products is available to applications and services on either a network or a device. The referring is a method of gathering and processing information from one or more sources. The method may comprise a single step or several steps of collecting product information from a plurality of sources and transmitting to a professional.

The information processed by a referral engine can relate to a client's shopping cart, products in shopping cart, nutrition facts of each product, UPC codes, images, analytical information that may identify the content, location, device, or the time of day. The referral engines may also correlate location, device, or time information to the client's particular activities at a location, with a given device, or at a given time. This allows the referral engine to help other applications such as a tracking application to track the user's location, daily food habits, routines, and allows applications and services accessing the client's personal profile to respond to the client's activity based on those correlations. In addition, the referral engine may collect demographic information, information about the user's interaction between multiple applications, and information about particular protocols the client is employing in interacting with the server.

Referral engine 28 interacts with database server(s) 30 to access the items and pre-determined characteristic tables, user's information, prior purchase history, etc. While the referral engine 28 can directly interact with database server 30, it possible to design the process wherein the referral engine 28 interacts with a search engine 28A which in turn searches the database server 28 to fetch the items required by the referral engine 28. Optionally the system may include a recommendation engine 28B that interacts with databases server(s) to fetch the products as recommendation for referred product. The information utilized by the referral engine 28 can be anything including UPC codes, nutrition facts, products codes, ingredient list, allergen information, user's personal data such as age, body mass index, health related information, biomarkers information such as fasting plasma glucose, hemoglobin levels, tracking information such as number of steps, biking or jogging information, genetic profiles, family history, etc. it can also interact with other independent referral applications and specialty applications such as content module 38, marketplace 36 and web interface 22 and third party application(s) 16. Another aspect of this invention includes a referral server to host the referral engine 28 to improve the efficacy of processes.

Web server 22 provides the client 14 a method or a means of accessing the network and its related applications. The client 14 can access at least one or more applications like payment 34, marketplace application 36, third party marketplaces, content application or referral module 28 via web server 22.

Database server(s) 30 is another key component of method of referring a user requested item to a professional according this invention. A database can be regarded as a set of a large number of tables related to products, services, places, events, individuals etc. Database servers are very important part of any network design. Database servers manage data for database clients. Data servers may store both raw information about products, services, patients and providers and processed information such as in a format that is secure and easily accessible to authorized application. They store the information generated by different application engines. There may be several data repositories located in the network for storing information including user profiles. For example, one data repository might partially or fully store only product information and another data repository may store only user profiles. In a typical database system, database clients issue database commands to the database servers to cause the database server to create logical storage structures, such as tables, and to insert, update, read and delete items within those logical storage structures. The items that are managed by the database servers, as well as the logical structures used to contain the items, are typically stored on non-volatile memory, such as magnetic disks provided by a storage system.

Before a database server can read or update data, the database server must retrieve the data from the storage system into volatile memory that is local to the database server. To prevent the same item from having to be retrieved every time it is needed, the database server typically stores the retrieved items in a buffer cache within the volatile memory that is local to the database server. Thus in larger networks, multiple copies of information may also be distributed across multiple data repositories to reduce network congestion when accessing information. Other configurations are also possible. The nature and number of data repositories such as database servers may vary according to the needs of the network where the present invention is to be deployed. Sometimes the information stored in database servers may be encrypted by an encryption code for security purposes.

The database 32 can be a distributed system of databases that includes food and grocery products stored under different servers under different categories such as “Prepared Food” database and a “Grocery” database, or may be combined into a common database. The products in database 32 may be preferably stored in a database as part of the cloud architecture, in some implementations the consumed foods database may be stored locally on the user device 14 or on client computer to facilitate rapid turnaround of information. Wherever the data is stored locally, the dataset may be limited to storing data regarding items relevant to by one or more users associated with the user device. The database 32 may comprise a list of known food products with their respective UPC codes, name variants for the food, nutritional content of the food on a per-serving or per-unit-mass basis. They can be tagged describing other popular name characteristics of the food such as vegan, Mediterranean, dairy-free, vegetarian, whole grain, grass-fed, GMO-free, Kosher, etc. The database 32 may be populated by any suitable means, including by manual updates or by importing from other foods databases such as the manufacturer's data, commercial databases, USDA National Nutrient Database and other similar sources of food information. The database 32 preferably includes almost all of marketed foods including those which are ready to eat prepared foods from restaurants and supermarket groceries, etc. While the items in database 32 is preferably to be universal, but may be limited to storing only foods previously indicated as being consumed by at least one user of the system.

Database server(s) 30 interacts with applications such as referral engine 28 and content module 38. Some of the data like item-pre-determined characteristic may often be created offline. In order to provide responses client requests, data may also be cached as web cache that is available to referral engine 28 dynamically and provide results to web interface 22 for client 14 via network 12. Alternatively there may be more than one database server and cache server to provide support for a large number of dynamic search and backend processes.

The web interface 22 specifically helps the application module 26 to accept requests from a client user 14 to Input information for referring at least one product. The request is transferred to application module and or referral engine 28 which may optionally search database server 30 for any additional information needed for referring at least one product to a professional. Still further, the referral engine 28 may optionally blind the use to remove information such as product's name and other identify information that identify the product prior to transmitting the item to the professional. The referral module 28 may also forward alert information to a client 14 connected via the same web interface 22 to provide a update. The web interface 22 is also used for automatic information transfer such as the checkout of products from cash registers or from a mobile device such as a cell phone or GPS or user mounted monitors.

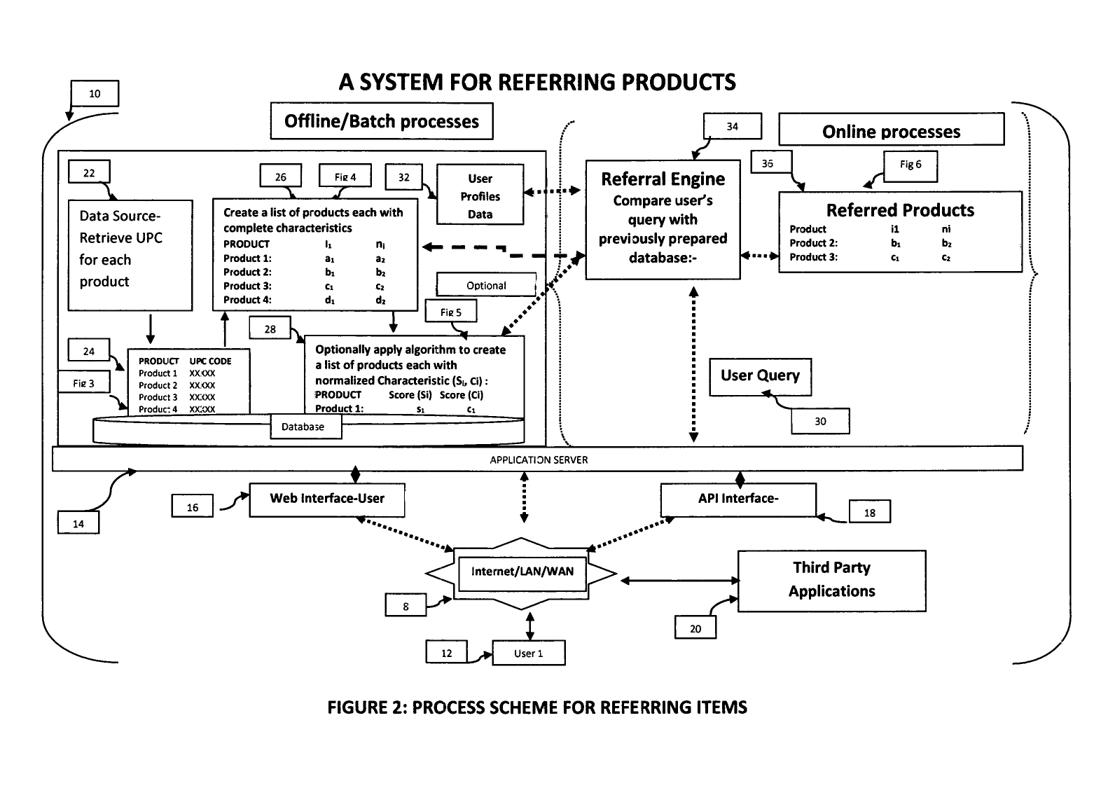

FIG. 2 provides an overview of illustrative processes for referring products according to this invention. The processes may all occur online dynamically or offline or a combination of both. For illustration FIG. 2 comprises processes conducted both offline and online and the processes and the sequence of processes are for illustrative purposes. A person skilled in art would know this is just one set of processes and one way of performing the processes and they can be easily modified with fewer or additional processes and carried out in different order to achieve the results of this invention. FIG. 2 illustrates the application of FIG. 1 framework providing processes for a system for referring products foods along with product characteristics such as nutrition facts including allergen list or an ingredient from the ingredient list, specific nutrition fact element total carbohydrate, sugar, protein, total fats, saturated fats or percent calories from sugar, percent calories from fats, percent calories from protein, percent calories from total carbohydrates, percent calories from fiber and percent calories from saturated fats.

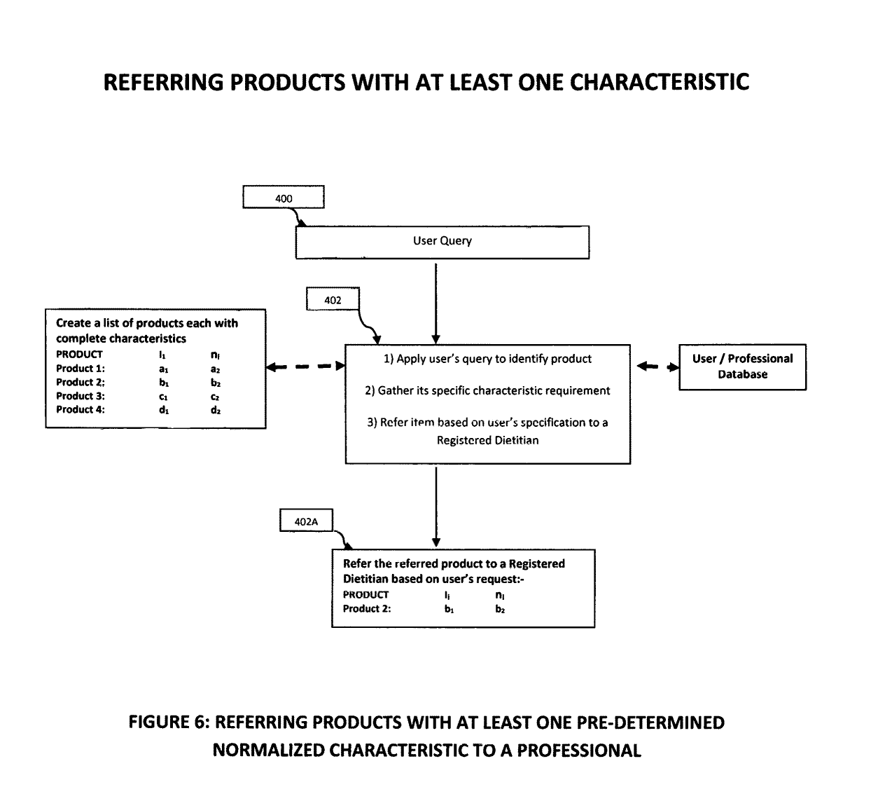

The FIG. 2 illustration includes a set of dynamic online processes that involve several parts of client-server network 10 including web server 16, application server 14 and API interface 18 to refer a product to a professional upon request 30 by client 12. Third party application server(s) 20 may contribute several capabilities to the client-server network 10 for seamlessly conducting search, recommend, refer and other transactional operations. The dynamic process involves client/user 12 to connect to the network and seeking referral to a professional upon a user query or request 30 via web interface 16. The request 30 may come from a web page or by scanning an image or reading out the product via voice or a text or voice message. The referral type may be specified either by selecting a characteristic in the user profile or typing in the search box to the application server 14. The application server 10 houses several applications as set forth in FIG. 1 including a referral engine 34 which may interact with other applications within the application server 14 and with third party applications 20 and with previously prepared database(s) 26 or optionally 28 which comprises item-pre-determined normalized characteristic such as Si or Cl. Referral engine 34 evaluates the query 30 submitted by the client 12 using an algorithm to ascertain referral criteria from user profile database 32. The profile created by the user 12 may include pre-determined requirement such as level or type of characteristic to be used in determining the items to be identified for referral to a professional. Thus the referral engine 34 refers a list of products that meet the query 30 and optionally profile 32 as referral output 36 as illustrated in FIG. 6 to exhibit them on the web interface 16 to the client 12. The actual presentation of the results may optionally be determined by the user or the referral engine or a standalone application that configures the output. For illustration, the order of the characteristic may be ascending order or descending order or the values may be equal to one another. The completion of feral of item according user query 30 may end with alert sent to client 12 including secure message, text, search or voice command and originate from server side interface.

The FIG. 2 involves just one set of processes that can be used for referring products according to this invention. The components of the FIG. 2 may be arranged, distributed, and combined in any of a number of ways in a cloud computing environment in which one or more of the components are provided by different processing and storage services connected via the internet or other communications system such as local area network or wide area network. The FIG. 2 illustration includes a set of backend and dynamic online processes that involve several parts of network 10 including web interface 16 and API interface 18 to receive the data and request 30 for referral from client 10. Third party application server(s) 14 may contribute several capabilities to the network for seamlessly conducting referring, search, recommendation and other transactional operations. The dynamic process involves client/user 12 connecting to the network and user entering inputs 30 via web interface 14. Application server 20 houses several applications as set forth in FIG. 1 including a referral module 28. The referral app may be single application or a series of specialty applications. When the referral app comprises a number of applications working together to generate a referral to a Registered Dietitian, they are either hosted together in the same application server 20 or in series of application servers.

In order to facilitate rapid response to request 30 from user 12, the system may configure its database in several forms. A typical supermarket contains over 20,000 food products and similarly a large number of restaurants prepare a variety of food products based on ethnicity and culture. But a typical individual buys an average of less than 250 preferred grocery and food items and probably consumes less than 300 prepared food products. The list of products relevant for a typical user 12 can be easily selected rapidly by pre-populating a table based on the user 12. However the database 28 is likely contain over 50,000 products to account for a wide range users who may use the system. Still further, an average user tends to use less than 25-50 products repetitively. Thus, while the most preferred grocery and food items may comprise all 250 products foods, the most heavily consumed database may contain the set of just the 200 foods that the user consumes and is substantially easier to parse than all the known foods. Since a majority of the database searches performed will involve searching for items that are similar to routinely consumed foods, and can begin with this smaller set of most heavily consumed foods. Thus, storing the foods that the user normally consumes separately and optionally in user local device makes selecting the foods database much more efficient when, for example, determining list of products in user query 30. Such a list may be populated in an App in the client's hand held device including a smart phone or a tablet.

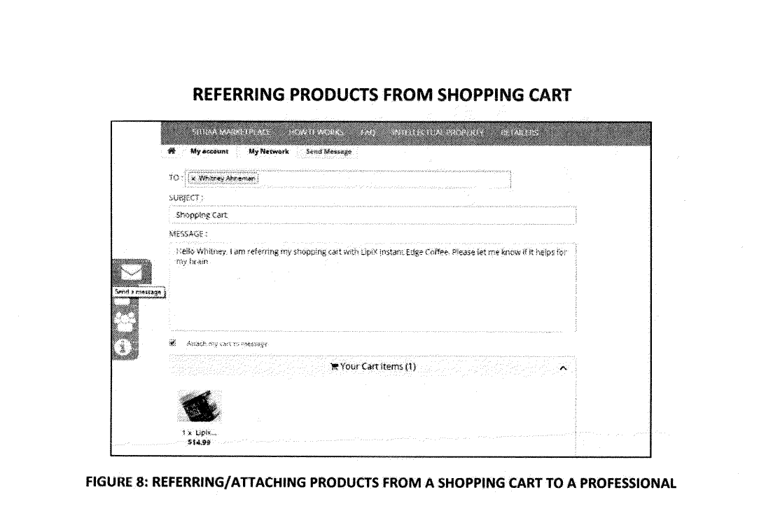

The referred product as per user query 30 in certain implementations is received at the web-user interface 16, with the first input indicating a product selected from product catalog or a pre-determined list. The second input identifying a list of products from the shopping cart by attaching the entire cart or selecting specific products by checking a selection box in a shopping cart as shown in FIG. 8. The method further includes transmitting one or both of these types of inputs to the application server 16 hosting the referral app 34. This step may also be in backend by a manual or an automated process involving uploading a flat file extracted passively from a device. For example, the gathered information is a list of grocery and food products purchased by an individual and a household. Once a product name gathered, it is matched with their product codes such as Universal Product Codes (UPC) or International Article Numbers (IAN) or European Articles Numbers (EAN).

In some implementations, the user 12 uses a device configured to scan a bar code of a product to enter the data. For example, the user 12 may use a scanning device to scan the barcode to indicate that as one of the foods the user is interested referring to a professional. Using a device to scan the product barcode allows for efficient and rapid logging of food entries because it avoids the need for the user to search through a list of foods to locate the consumed food. Using a scanning device to scan the product code also avoids the need for the user to enter product characteristics of the food. It also helps capture the time and geolocation from where the user 12 is updating the profile to generate the referral to local professional because the location of scanning may be used a default location to identify a local professional. Instead, the user 12 may use a mobile device to quickly scan the barcode, and the application server 14 may use the barcode data to quickly locate the scanned item in a database. The database 32 usually stores the product identifiers such as UPC codes or EANs, identifying the nutrition facts, ingredients and allergen using scanning codes makes the task of locating the scanned item more efficient. The data stored in include client's recipe, meals breakfast, dinner, snacks, beverages, serving sizes, weight of products, extent of utilization, device, location, or the time of day. The referral, recommendations engines may also correlate location, device, or time information to the client's health condition, with a given device, or at a given time. This allows the referral engine to track the user's daily routines and allows applications and services accessing the client's personal profile to respond to the client's activity based on those correlations. In addition, the system may also collect demographic information, application information, information about the user's interaction between multiple applications, and information about particular protocols the client is employing.

Further the user 12 may use the barcode to indicate that the user is considering purchasing the product enabling onsite confirmation from a professional or if any to make alternate recommendation to the user referred product. The user device 12 may be equipped with scanning application that can scan the product code to display the product information to the users to help the shopper decide whether to refer the product.

The product code, image or name is either mapped to its nutrition facts, ingredients list and allergen information from an internal data source or gathered from a separate process. For each product, in addition to ascertaining the product name, the referral process may involve determining it is consumed by an individual. For example, in addition to identifying the breakfast cereal referred by an individual, a professional may need the information about how many servings user may plan to consume in order to determine its utility for the consumer.

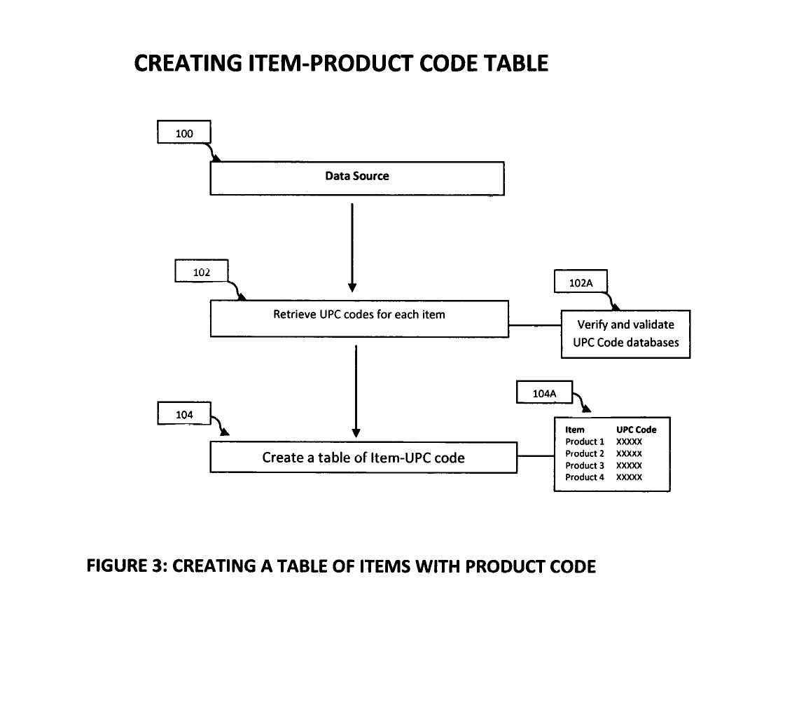

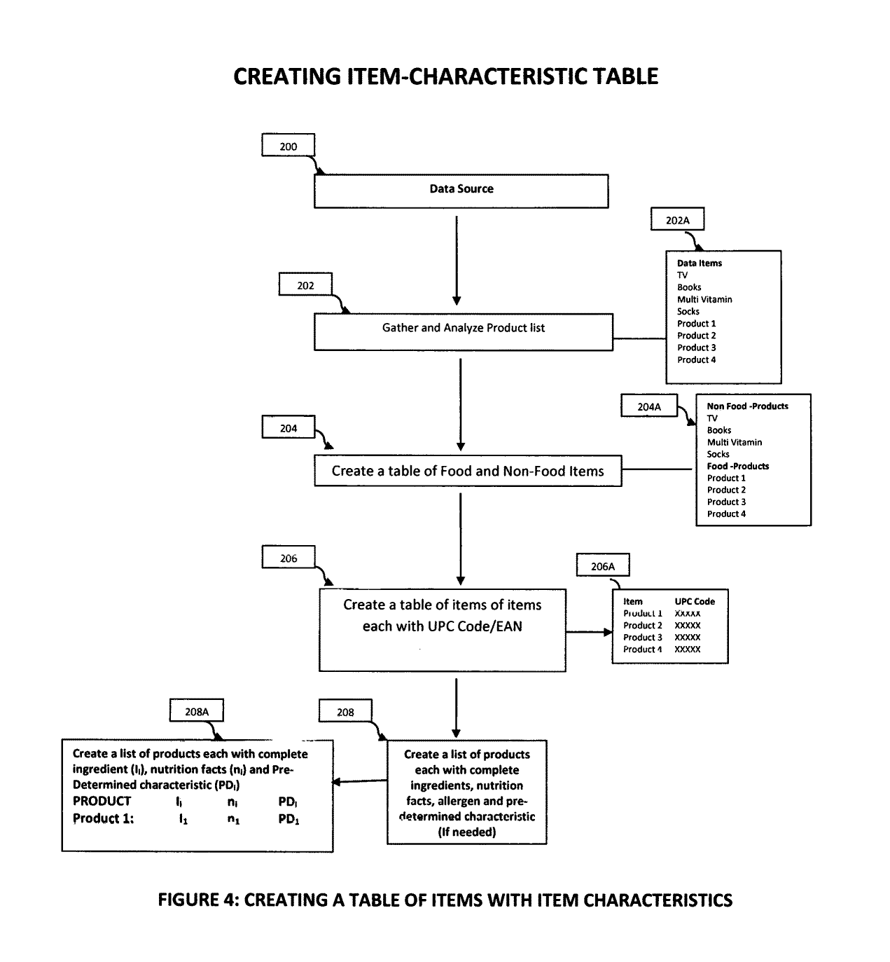

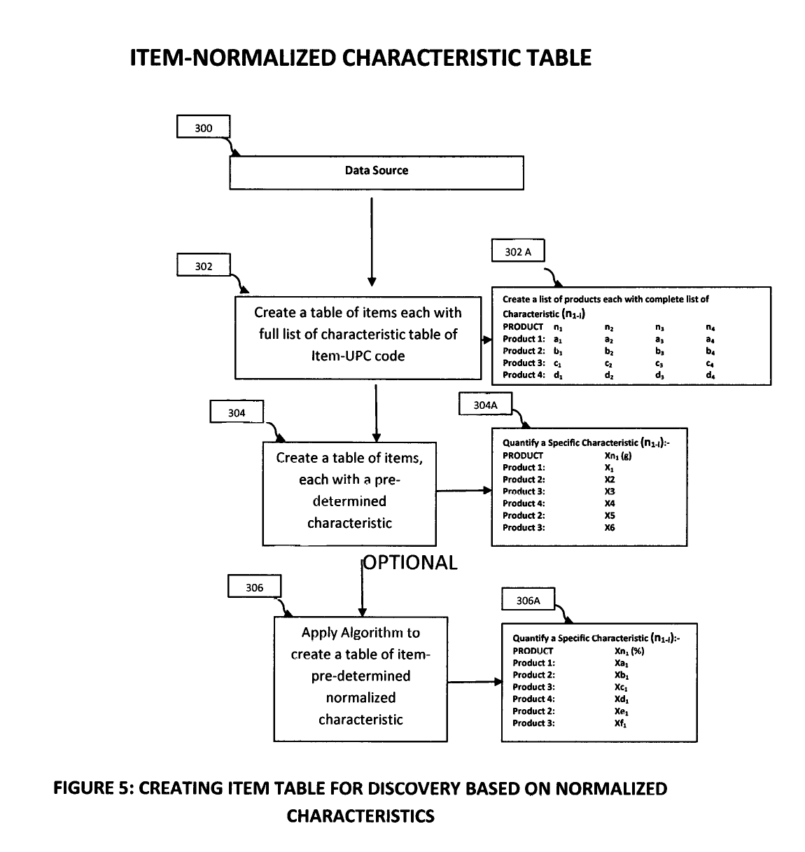

The system may optionally involve two sets of processes to facilitate the system for referring products to a professional according to this invention. The batch processes are often conducted offline to create the content needed that are optionally sent to a professional in a referral process which is conducted dynamically online by user triggered events. The data source 22 can be any format—digital or paper or manual entry of information to link each product names (generic or brand or category names) with respective product codes such as International Article Number (EAN) or Universal Product Codes (UPC). This process enables item-product code 24 as illustrated in FIG. 3. Once generic product names are matched with their respective product codes, the each product code is matched with their complete characteristics such as nutrition facts, product content and product properties or measures in 26. The item-characteristic table 26 shown in FIG. 4 may not always be useful for comparing product because differences in products—volatile organic compounds (VOC) in a solid paint and liquid paint, sugar content in two food products with different sizes, the quality of air in two rental rooms in two different flours, two flights with identical ticket price but with different leg rooms and or different net flying times etc. The characteristics in the item-characteristic table 26 may optionally, upon certain additional calculations and processes may result in standardized or normalized characteristics that enable product to product comparison. Applying an algorithm to item-characteristic(s) table 26 results in item-normalized characteristic(s) 28 as illustrated in FIG. 5. The algorithm can be any computational calculations or modifications to the characteristics in table 26. They include conversions using density, air quality parameters, distance between two objects, mathematical multiplications, divisions, subtractions, differentiations and integration, etc. The only requirement is that the algorithm(s) used must result in a characteristic in table 28 that is different from the one in table 26 and must enable product to product comparison on the basis of at least one characteristic such as percent VOC in paint or percent sugar or net percentage carbon monoxide or net percentage air pollutants in two rental rooms, etc.

The entire process of identifying the product and determining its utilization can be just online alone or just offline alone or a combination of both online and offline processes. It can be designed in such a way that some or all of the processes may be performed on client's device or entirely on server. The processes disclosed in the Figures are for illustrative purpose and may be performed in a different order easily known to person skilled in the art of designing and developing such products.

The system may gather other information including details such as image of the product, product code, product names, nutrition facts, ingredient list personal information, health information, laboratory data, medical claims data, pharmacy claims data, referral post hospital discharge data, health risk assessment, insurance premiums, magazine subscriptions, events, functional status data, laboratories values, pre-notification or authorization data, activity data such as biking distance, patient related information such as blood pressure, blood work data, tracking information of device, product check out from cash register, data extracted from a rewards program, browsing behavior, clinical data, descriptive and quantitative information, etc to enable a Professional to determine the utility of referred product and alternate products.

In order for the system to rapidly identify products and relate them to their product characteristics, the products are stores in the database. The grocery products are usually identified using their EAN or UPC codes. However, those are one set of product codes and system can generate its own codes for identification purposes. FIG. 3 illustrates the processes for identifying item-product codes. In one embodiment, this table is useful for referring products by identifying product codes. The data from data source 100 is extracted to verify 102 the product codes and may involve accessing third party applications 102A. The verification may be simple spreadsheet command or a written code within an application. Once the respective product codes are verified, they are mapped 104 to create a table of item-product codes 104A. The product codes can be anything that characterizes the product such as universal product codes (UPC) or international article number (EAN) etc. This table may be prepared by an offline process or by simply importing such product-item codes as a data file in the form of an Access or an Excel or PST file. It can also be accessed dynamically using a third party application or manufacturer or regulatory agency (For instance—US department of Agriculture or USFDA) databases.

FIG. 4 illustrates a set of processes to assess the data and create a table of Item (Product Code)—Product Characteristics or Product Attributes. The product attribute or characteristic can be anything that defines at least one aspect of product such as its constitution, performance, or quality etc. For Example—each element in a nutrition fact of grocery product is an attribute. Similarly an ingredient from an ingredient list or the impact of product on fasting plasma glucose upon its consumption. There are reported to be over 200,000 food products and several thousand new products are introduced every year. System according to this invention uses data files in the form of an Access or an Excel or PST file. Usually commercially available data files may comprise several unrelated product categories. The data items from data source 200 are gathered and analyzed 202 to identify and separate items 202A. The objective is to separate food items from non-food items/services and map each food product to their respective product codes to create a table. The shopping list 202A is assessed 204 for food/non-food products 204A. The food products from the table 204A are identified 206 for their respective product codes (for example—UPC code) and an item-product code 206A is created. The final step is to create a list of item-characteristics for each item tagged with their respective product codes by analyzing 208 each item (UPC code) for their complete list of characteristic features to create an item-characteristic table 208A. As described earlier item-characteristic could be UPC code-Sugar content or UPC-Carbohydrate content etc. UPC codes are used for identifying the items and each item can also be represented by other products, names or symbols. The sequence of steps shown in FIG. 4 is for illustrative purposes and one or more of the steps can be substituted or completely removed to achieve the desired table of item-product characteristics 208A. It is possible that the entire process be avoided by loading previously created item-characteristics table from a third party source or accessing it via third party application 16 as shown in FIG. 1.

FIG. 5 is illustrative representation of processes to generate an optional item-normalized characteristic table that is used in a database for the system for referring products according to this invention. Normalized characteristics are helpful in situations where the same characteristic has different absolute values within same protect categories or when the nature of the products is different. For example; macronutrients in a nutrition fact label routinely are displayed as number of grams per serving size. The serving size tends to change depending on the type of product (Liquid or Solid) or the manufacturers. Kellogg's Raisin Bran may have different serving size compared to the Raisin Bran marketed by General Mills. In such cases the product to product comparison doesn't enable a user to easily determine the impact of two products. Instead of absolute amount, if the characteristics such as macronutrients are converted to relative percentages, the product comparisons become more valid. How a product characteristic is normalized is illustrated using macronutrients as example. For instance, it may be ratio of Fats to Total Macronutrients or Total Carbohydrates to Total Macronutrients or Protein to Total Macronutrients. For Example; If an item comprise four key nutrients A. B. C and D among others, the relationship between these characteristics and derived characteristic could be the ratio N1=A/(B+C+D), N2=B/(B+C+D). N3=C/(B+C+D). N4=D/(B+C+D) or N5=(A+B)/(C+D) or have weighted relationship such as x*A+y*B:C+D. For example the nutrition fact may include Fat Percent-20.09%. Carbohydrate Percent-62.76%, Protein Percent-17.15%, Sugar Percent-14.65% and or a derived score which assigns further weights to each of these percentages. For instance—A) Sugar Ratio: 0.15, B) Carbohydrate Ratio: 0.63, C) Non Carbohydrate Ratio: 0.37, D) Sugar to Non Carbohydrate Ratio: 0.39. E) Carbohydrate to Non Carbohydrate ratio: 1.69 and an optional Derived Score: 0.72 which provides 75% weight to Sugar to Non Carbohydrate Ratio acrd 25% weight to Carbohydrate to Non Carbohydrate ratio.

The normalization step is optional and is only included to illustrate the application of invention to include normalized characteristics to help product to product comparison. The processes involve algorithm(s) that routinely conduct batch operations offline and online to update this table periodically. The data from data source 300 was assessed to create an item-complete characteristic table 302A as described under FIG. 4. However the simple characteristic from item-complete characteristic table 302A more often do not enable product to product comparable. In order to enable such product to product comparison, at least one characteristic is chosen 304 from the item-complete characteristics of table 302A and the item-specific characteristic is in table 304A. An algorithm 306 can be used to convert the pre-determined characteristic into a standardized or normalized characteristic in table 306A. More specifically the standardized characteristic Xₐ₁ of Product 1 and X_{b1} of Product 2 enable compare product 1 with product 2. It is possible each of the characteristic from table 302A is converted to standardized characteristic with an algorithm 306 to create an item-standardized characteristic where at least one characteristic is a standardized characteristic that enable product to product comparison. Normalized characteristics may aid the professional in rapidly determining the utility of products to a user easily than the raw characteristic such as absolute value of calories or level of viscosity or volatility or a macronutrient such as carbohydrate content in a serving.

FIG. 6 is a schematic illustration of how a referral engine 402 may refer products as specified by a client by comparing it with the item-characteristic and item-normalized characteristic tables created in FIG. 4 and FIG. 5 respectively. The user query 400 was assessed by referral engine 402 based on user query to identify the product and any desired specific characteristic requirement. The item is referred from the database 26 from FIG. 2 and the list of products displayed on the web server 402A. In another embodiment of this invention, the referred product may optionally include a list of alternatively products. Such a list of alternate product to a referred product may optionally be listed in ascending or descending order of a pre-determined characteristic depending on the user's specification. The referral engine may interact with different application modules such as a database in the App server to fetch the right product, user and professional related information. The user's specification can be anything such as a specific Registered Dietitian who may be user's personal Dietitian or sometime to verify if the professional is from a specific location.

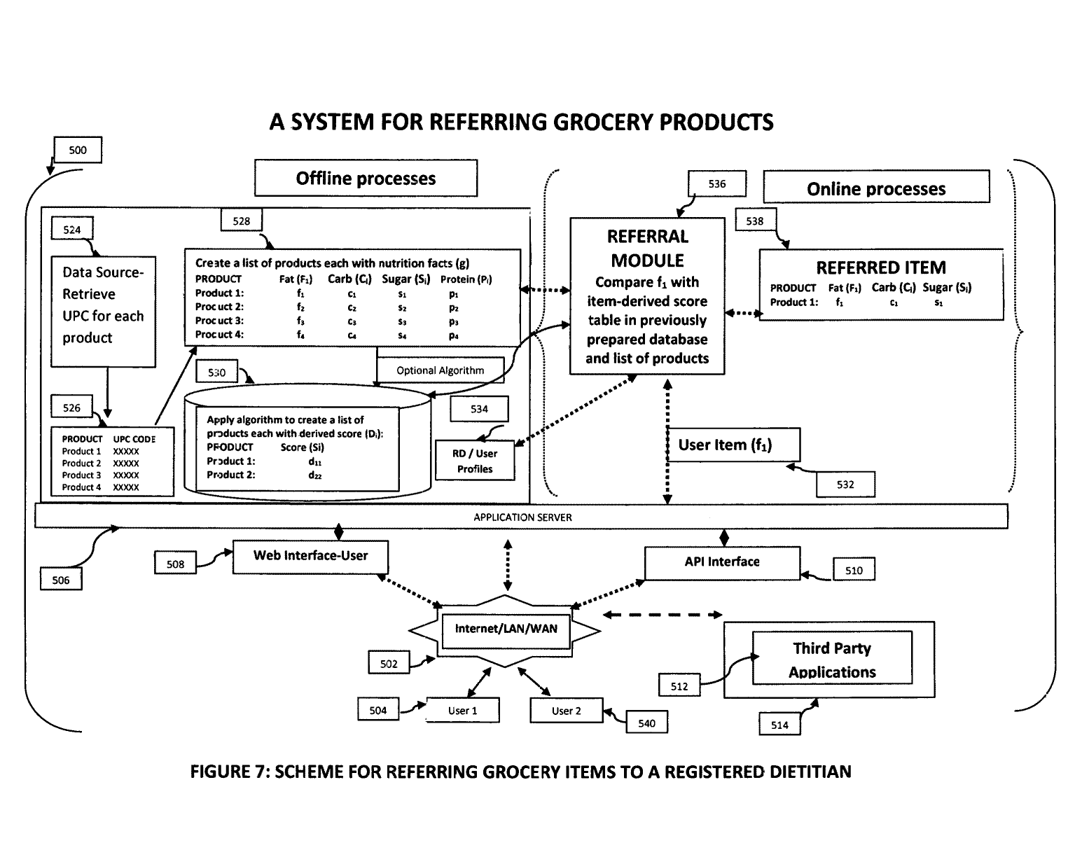

FIG. 7 is one specific implementation of invention for referring products based on a characteristic in food products. The sequence of steps shown in the FIG. 7 is illustrative and some of the steps could be performed in a different order of sequence or eliminated altogether.

The FIG. 7 is just one illustration of a method of referring food products to medical professional such as professional dietitian to evaluate the suitability for the user. It can be implemented in several ways using different variables depending on the requirements. The features sugar, carbohydrates, fats, protein etc are used in this specific instance. It could be ability of an item to lower fasting plasma glucose or the ability to improve satiety or modulate a hormone or aid specific activity such a biking or hiking. What is important according to this invention is that the extent and ability of a normalized product characteristic of the referred product rather than a characteristic that is not helpful in comparing products. It is perfectly possible the desired characteristic could be the content of an allergen or a preservative or artificial dye or even just the quantity of the product in another situation. The referral of an item can be from any device such as including but not limited to desktop computers, laptop computers, mobile devices including a smart phone, tablet computer, personal digital assistant, set top boxes (e.g., for a television), televisions, video game consoles, home appliances (e.g. a refrigerator, microwave oven, washer, or dryer) or any other devices having appropriate processor, memory, and communications capabilities for interacting with the user and communicating with network as disclosed in this invention. It can be from any part of the site webpage, catalog, text or images or even physical product by comparing the picture and is independent of the operating system.

FIG. 7 is a network with a client-server architecture connected via internet or LAN or WAN. The server system is composed of offline/batch processes and online dynamic processes. Client-server architecture 502 provides the networking framework for client side 504 and third party application interface 522 and server side comprising application server 506 and at least one database 230. The server side application server can comprise several modules and servers. They include an application server 506, web interface 508 to client side, at least one API interface 510. The application server 506 houses several modules of applications such as marketplace, payment, content and other application as described under FIG. 1. The processes that facilitate the referral method according to this invention can be offline/batch processes and online dynamic processes. The processes are grouped under offline and online processes for illustrative purposes. It is possible to complete the several offline processes dynamically by providing computing power and the content needed to complete the process. To facilitate the referral of products, the system involves creation of an item—characteristic table 528 starting with a data from data source 524. For instance the data could be an excel sheet of products, product codes, nutrition facts, allergen list, ingredient list and other information that is interest. In order to tag each product to its list of complete characteristics (such as nutrition facts), the invention could use a product code such as UPC code or CAN or even alphabetical codes generated automatically by the system. The produce-item table is mapped to respective characteristic list—more specifically, all elements of nutrition facts, allergen list, ingredient lists, other characteristics that may be related to the product (ex. vegan, gluten-free) or the processes of production (organic, GMO-free) are captured by one of more algorithm 528 to create a table of item-characteristic. An optional aspect of this invention relates to the system for referring products results in a list of items that enable product to product comparison. In order to facilitate such method, the system uses at least one algorithm 530A to normalize at least one pre-determined characteristic—sugar content in grams to a normalized characteristic—a ratio of sugar to the sum of carbohydrates, protein and fats in each product. This provides sugar ratio that enables how one product compares to another on the basis of this ratio. Two products with sugar percentage of 30 provide same amount of sugar upon consumption of equal amount of products irrespective whether one is a cereal and the other is a bean. The item-normalized characteristic table provides a database against which client's 504 query presented dynamically, is compared to determine the products that meet the query. The characteristics Fat (Fᵢ), Carb (Cᵢ), Sugar (Sᵢ), Protein (Pᵢ) etc are the absolute numbers available from the nutrition facts of a grocery product in table 528. The scores Si is normalized characteristic such as percent sugar or percent carbohydrate or percent fats or percent protein value in a product. For example—item-characteristic table 528 would have the Post Raisin Bran Cereal (UPC-884912114709) based on simple nutrition facts table are 46 g of Total Carbohydrate, 19 g of Sugar, 5 g of Protein in one cup serving size. Optionally these values may be normalized to facilitate the product to product comparison. When these absolute numbers from item-characteristic of 528 are normalized to create an item-normalized characteristic table 530. Thus the normalized value of Total Carbohydrate is 88%, normalized value of Sugar is 37% and normalized value of Protein is 10%.

FIG. 7 further illustrates a Client-Server network 500 where a Client 504 uses network 502 and web interface 508 to seek product referral sending query 532. The Client-Server network may further comprise third party applications 512 which may be hosted in 514. The query 532 is sent via web interface 508 to the application server 506 which houses referral engine 534 among other applications. The item-characteristic table 530 and user profile 534 are in database server(s) as described FIG. 1. The web interface 508 can be any device such as to desktop computers, laptop computers, mobile devices including a smart phone, tablet computer, personal digital assistant, or any other devices having appropriate processor, memory, and communications capabilities for interacting with the user and communicating with network. The application server 506 may be just be a single server or a series of specialty application servers hosting several applications including the referral engine 536 to process the user specified query 532. The referral engine interacts with database servers for user profile 504, RD profile 534 and the item-characteristic table 530 to gather information needed for the referral. It may also interact with other applications such as marketplace, recommendation engine, search engine, content module etc as needed during the referral process.

The UPC-nutrition facts 528, the optional UPC-normalized nutrition facts such as UPC-Carbohydrate Percent, UPC-Fat Percent, UPC-Protein Percent, etc may be generated using a data source 526 as described in FIG. 3, FIG. 4, FIG. 5 and FIG. 6. The actual characteristic used is not limited to nutrition fact elements or macronutrients. It may be an ingredient, or a biomarker result of product utilization (ex. Fasting Plasma Glucose) or a characteristic such as a density.

The referral engine 534 can be use either dynamically with User 504 sending a request to refer products 536 or it can also done offline at a user designated timing trigger. The request 532 is transmitted to referral engine 534 and optionally to other applications to elicit a one or more non-transitory computer-readable media of a server or a portable device of a consumer having collectively thereon computer-executable instructions when executed tact a product 538 to a Registered Dietitian. The product is displayed to a Registered Dietitian (A second client) 540 again via web interface 508. The completion of referral process may be alerted to both clients as a message. In other implementations, the referred products are displayed to a Registered Dietitian alongside a list of alternative product arranged in ascending or descending order based on a desired characteristic. For instance, a referred product with a carbohydrate percent of 70% is displayed with a list of four similar products with lower carbohydrate percentages than 70% arranged either by increasing or decreasing order of carbohydrate content to facilitate the Registered Dietitian to make a determination which is a better alternative for the user.

The implementation illustrates the referring grocery item to a Registered Dietitian to provide advice on the utility of grocery item. In other implementations such as paints, the professional is a painter or a carpenter in case of logs or a chemist in case of a cosmetic etc.

FIG. 8 illustrates a computer display of Client referring his/her shopping cart product with a message to a Registered Dietitian.

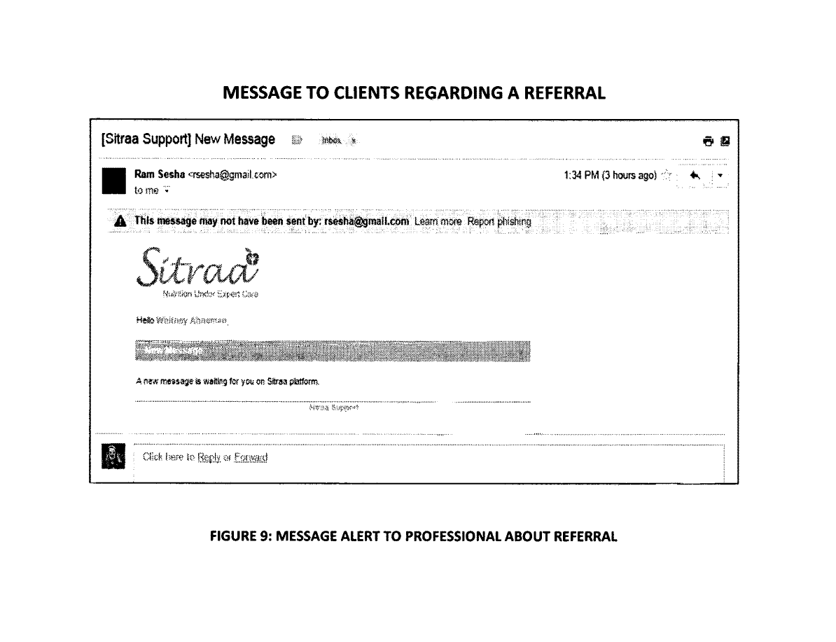

FIG. 9 illustrates a message alert received by a Registered Dietitian upon referral of shopping cart products

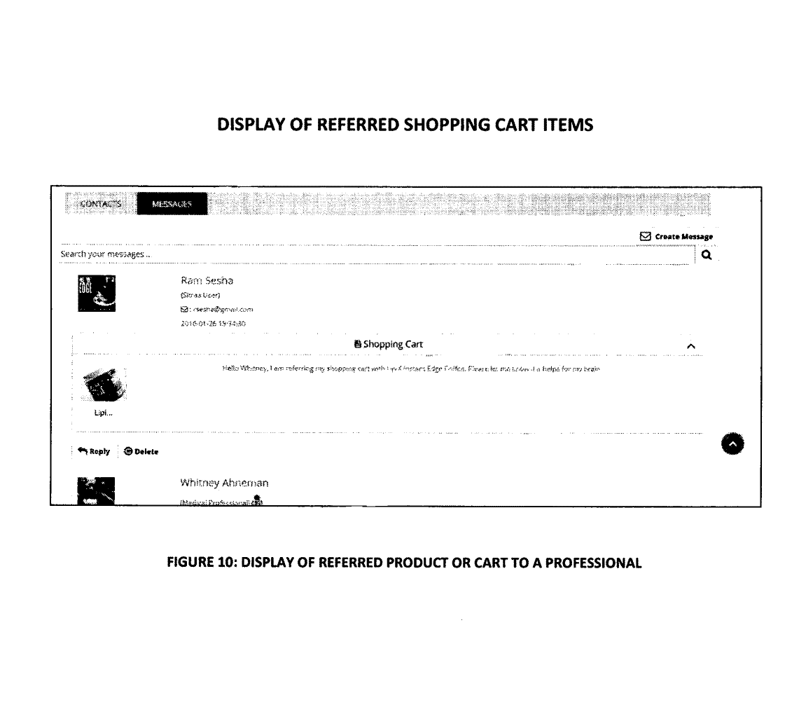

FIG. 10 illustrates the display of referred product to a Registered Dietitian

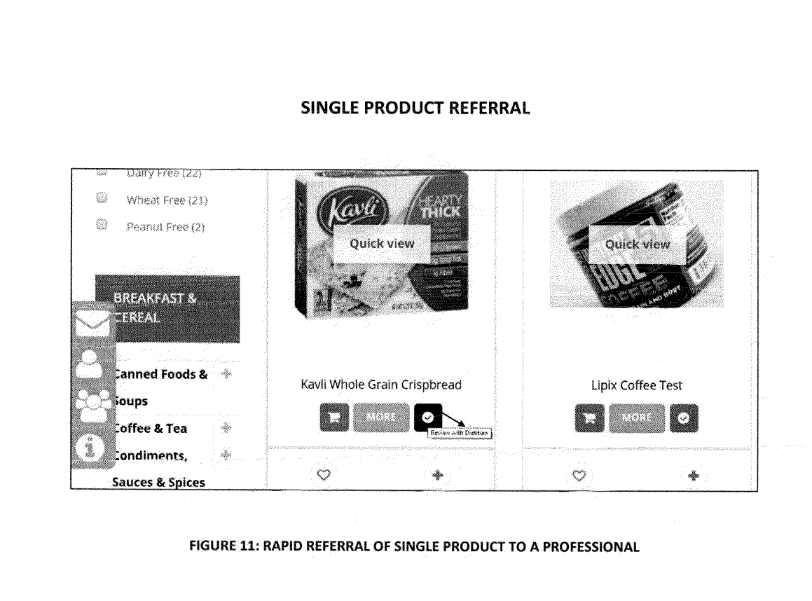

FIG. 11 illustrates one method of enabling raid referral of single product with an Icon on display

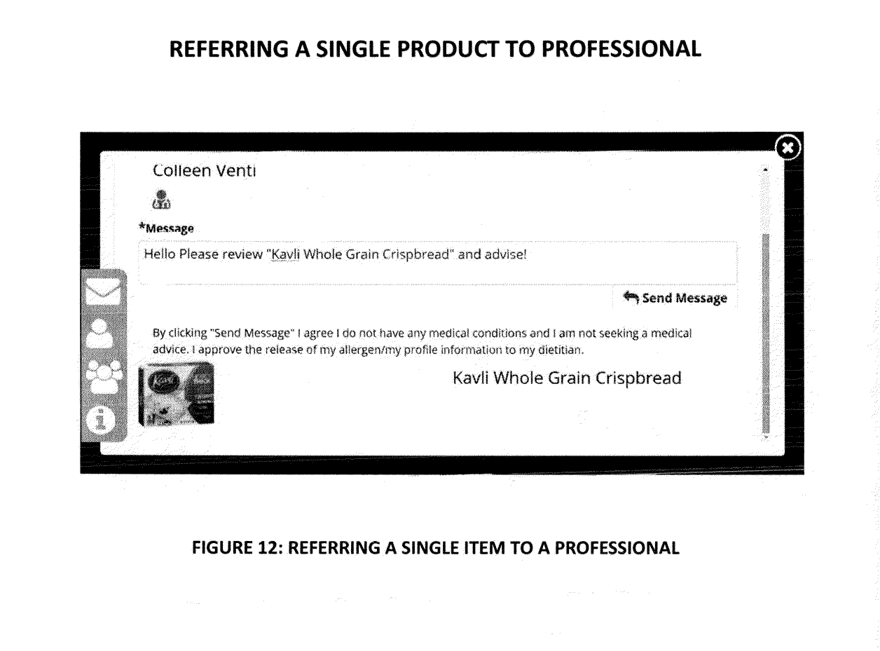

FIG. 12 illustrates the message of rapid referral of single product to a Registered Dietitian.

One or more embodiments of the invention include a platform which can be used to refer products, connected to a patient with medical condition and a healthcare professional to provide to the user.

Thus the invention provides a computer implemented referral system that hips a professional to use an item characteristic to personalize the recommendation to a user by mapping the item ranked using at least one item characteristic with the user's profile.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer, Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

The invention has been described with reference to several exemplary embodiments, but it must be understood that the words have been used are words of description and illustration, not the words of limitation. Changes can be made within the purview of the appended claims, as presently stated and as amended, without departing from the scope and spirit of the invention in its aspects. Although the invention has been described with reference to particular means, materials and embodiments, the invention is not to be interpreted as limitations because of the specifics of the description; rather the invention fully extends to all functionally equivalent structures, methods, and uses such as are within the scope of the appended claims.

The term “computer-readable medium” shall also include any medium that is capable of storing, encoding or carrying a set of instructions for execution by a processor or that cause a computer system to perform any one or more of the methods or operations disclosed herein. Though the computer-readable medium is shown as just a single medium, the term “computer-readable medium” includes a single or multiple media, such as a centralized or distributed database, and/or associated caches and servers that store one or more sets of instructions. The term “computer-readable medium” includes not just the a solid-state memory such as a store card, a memory card or other package that houses one or more non-volatile read-only memories but also a random access memory or other volatile re-writable memory, a magneto-optical or optical medium, such as a disk or tapes or other storage device to capture carrier wave signals such as a signal communicated over a transmission medium. Thus the disclosure is considered to include any computer-readable medium or other equivalents and successor media, in which data or instructions may be stored.

Although the specification as written describes components and functions that may be implemented in particular embodiments with reference to particular standards and protocols, the disclosure is not limited only to such standards and protocols. For example, standards for Internet and other network systems such as Wi-Fi, Bluetooth, microcell and the like represent examples of the state of the art. However the standards that prevail today are periodically superseded by faster or more efficient equivalents having essentially the same functions. Accordingly, the invention's scope includes such replacement standards and protocols having the same or similar functions are considered equivalents thereof.

The illustrations shown in the specification are not intended to serve as a complete description of all of the elements and features of apparatus and systems that utilize the structures or methods described herein. The illustrations of the embodiments described herein are intended to provide a general understanding of the structure of the various embodiments.

In addition, many other embodiments of this invention may be apparent to those of skill in the art upon reviewing the disclosure. The scope of this invention includes other embodiments that may be utilized and derived from the disclosure, such that structural and logical substitutions and changes may be made without departing from the scope of the disclosure. Further, the illustrations are merely exemplary and representational and are not intended to accurately drawn to scale. For the purposes of clarity, certain drawings and representations within the illustrations may be exaggerated, while other drawings and representations may be minimized. Accordingly, the disclosure and the figures are to be regarded as illustrative rather than restrictive of the scope of the inventions.

The term “invention” as used herein is merely for convenience and without intending to voluntarily limit the scope of this application to any particular invention or inventive embodiment or concept. Combinations of the above embodiments, and other embodiments not specifically described herein, will be apparent to those of skill in the art upon reviewing the description. One or more embodiments of the disclosure may be referred to herein, individually and/or collectively no way limit the scope of the term “invention”. Moreover, although specific embodiments have been illustrated and described herein, it should be appreciated that any subsequent arrangement designed to achieve the same or equivalent purpose may be substituted for the specific embodiments described in the specification. This disclosure is intended to cover any and all follow up adaptations or variations of different embodiments.

The disclosed subject matter of this invention is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the detailed description, with each claim standing on its own as defining separately claimed subject matter.

The abstract of the disclosure is not intended to be used to interpret or limit the scope or meaning of the claims. In addition, in the foregoing specification, various features may be grouped together or described in a single embodiment for the purpose of streamlining the disclosure.

In the claims which follow, any reference characters used to denote process steps are provided for convenience of description only, and not to imply a particular order for performing the steps.

1. A computer-implemented method for referring an item to a Professional, comprising:
receiving a request to refer an item from a client; and
transmitting the request comprising item information to a Professional.

2. A computer-implemented method of claim 1 wherein the number of steps involved in referring the product is two steps.

3. A computer-implemented method of claim 1 wherein the number of steps involved in referring the product is three steps.

4. A computer-implemented method of claim 1 wherein the transmitted request comprise at least one product characteristic.

5. A computer-implemented method of claim 1 wherein the referred item is a food product.

6. A computer-implemented method of claim 1 wherein the professional is a nutritionist or a chef.

7. A computer-implemented method of claim 1 wherein the transmittal of request generates an alert to clients.

8. A system, comprising:
at least one computing device, configured to at least:
to receive a request to refer an item from a client;
select an item from an electronic catalog; and
transmit the item information to a Professional;

9. A system of claim 8, wherein the Professional is a nutritionist or a chef.

10. A system of claim 8, wherein the transmittal generates an alert to all the parties.

11. A system of claim 8, wherein the item is a food product.

12. A non-transitory computer-readable medium embodying a program executable in a computing device, the program, when executed, causing the computing device to at least:
receive request to refer an item from a client;
select an item from an electronic catalog; and
transmit the item information to a Professional

13. A non-transitory computer-readable medium of claim 12, wherein the Professional is a nutritionist or a chef.

14. A non-transitory computer-readable medium of claim 12, wherein the transmittal generates an alert to all the parties

15. A non-transitory computer-readable medium of claim 12, wherein the item is a food product.
